(19) United States
(12) Patent Application Publication
(10) Pub. No.: US 2005/0108235 A1
(43) Pub. Date: May 19, 2005

(54) Information processing system and method

(76) Inventors: Akihisa Sato, Yokohama (JP); Yasufumi Uchiyama, Ebina (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/811,878

(22) Filed: Mar. 30, 2004

(30) Foreign Application Priority Data
Nov. 18, 2003 (JP) 2003-387958

(51) Int. Cl. G06F 7/00

(52) U.S. Cl. 707/9

(57) ABSTRACT

An information processing system comprises an information processing apparatus and a management host. The information processing apparatus is used to operate a plurality of applications to request data input/output from a storage. The management host manages the storage. The information processing apparatus comprises an access monitoring section. The access monitoring section monitors an access request from the application and obtains information about the access request for each of the applications. The management host comprises an acceptance section, an estimated load calculation section and a load data output section. The acceptance section accepts specification of a new application. The estimated load calculation section calculates estimated load data in case of addition of the application based on information obtained by the access monitoring section. The load data output section outputs estimated load data calculated by the estimated load calculation section.

### BACKGROUND OF THE INVENTION

The present invention relates to an information processing system, its control method, and a program. More specifically, the present invention relates to optimization of a storage.

Conventionally, a volume allocation system has a logical volume group that is divided into a plurality of logical volumes. An I/O configuration information management means is used to obtain logical volume configuration information for each allocated logical volume. An allocated volume list is configured to contain the other logical volumes in the same logical volume group including allocated volumes. The logical volume configuration information is obtained from the I/O configuration information management means for each allocated logical volume. A logical volume having the lowest I/O load is selected from a group of volumes to be allocated. The other logical volumes in the same volume are excluded from the allocation. In this manner, there is proposed a technology for optimizing the volume allocation and improving an access response and the throughput (e.g., see JP-A No. 320126/1998).

Further, a port control section is provided with a function capable of not only accepting requests from a host, but also issuing requests to the other storage controllers. This enables online and backup processes simultaneously. When a plurality of ports is used, the ports are selected and scheduled according to loads. In this manner, there is proposed a technology to decrease a ratio of degradation in the performance of online applications due to backup operations (e.g., see JP-A No. 259063/2002).

The above-mentioned conventional technologies obtain load information from the storage. It is possible to obtain the load information about the storage in its entirety, but not the load information about each application that uses the storage. Further, accesses from the application to the storage vary with the lapse of time. Consequently, accesses may concentrate on specific hardware resources during a specific time slot. No consideration is given to optimally distributing the accesses. For example, a storage resource allocation management program can be used to specify an application and add a new directory to the file system. In such case, allocating a new volume may adversely affect execution of the existing application.

### SUMMARY OF THE INVENTION

It is an object of the present invention to appropriately distribute loads when a new application is to be added. To do this, calculating a load of each application can make clear which application increases a load on which hardware resource causing a bottleneck.

The present invention provides an information processing system comprising: an information processing apparatus which is used to operate a plurality of applications to request data input/output from a storage; and a management host which manages the storage, wherein the storage and the information processing apparatus constitute an access process section for processing an access request from the application; wherein the information processing apparatus comprises an access monitoring section which monitors an access request from the application and obtains information about the access request for each of the applications; and wherein the management host comprises: an acceptance section which accepts specification of a new application; an estimated load calculation section which calculates estimated load data in case of addition of the new application based on information obtained by the access monitoring section; and a load data output section which outputs estimated load data calculated by the estimated load calculation section.

When a new directory is added to the file system to allocate a new volume, the present invention can appropriately distribute loads without adversely affecting execution of an existing application.

### BRIEF DESCRIPTION OF THE DRAWING

FIG. 1 is a block diagram showing an overall configuration of an information processing system according to an embodiment of the present invention;

FIG. 2 is a functional block diagram mainly showing a host 10 of the information processing system according to the embodiment of the present invention;

FIG. 3 is an explanatory diagram of an AP-STORAGE correspondence table (TABLE1) according to the embodiment of the present invention;

FIG. 4 is an explanatory diagram of access information (TABLE2) stored in buffer memory 210 according to the embodiment of the present invention;

FIG. 5 is an explanatory diagram of an access information table (TABLE3) according to the embodiment of the present invention;

FIG. 6 is an explanatory diagram showing a scheme of calculating estimated loads according to the embodiment of the present invention;

FIG. 7 is an explanatory diagram showing an estimated load on an array group 1 (port FC1) according to the embodiment of the present invention;

FIG. 8 is an explanatory diagram showing an estimated load on an array group 2 (port FC2) according to the embodiment of the present invention;

FIG. 9 is an explanatory diagram showing another scheme of calculating estimated loads according to the embodiment of the present invention;

FIG. 10 is a flowchart showing a process of reading data using a DB driver according to the embodiment of the present invention;

FIG. 11 is a flowchart showing a process of writing data using the DB driver according to the embodiment of the present invention;

FIG. 12 is a flowchart showing a monitoring process for data reading using a file system according to the embodiment of the present invention;

FIG. 13 is a flowchart showing a monitoring process for data writing using the file system according to the embodiment of the present invention;

FIG. 14 is a flowchart showing a process of an access information output section 1 according to the embodiment of the present invention;

FIG. 15 is a flowchart showing a process of an access information output section 2 according to the embodiment of the present invention;

FIG. 16 is a functional block diagram of a management program 250 according to the embodiment of the present invention;

FIG. 17 is a flowchart showing a current load calculation process 1 according to the embodiment of the present invention;

FIG. 18 is an explanatory diagram of connection information (TABLE4) with a storage according to the embodiment of the present invention;

FIG. 19 is an explanatory diagram of current load data (TABLE6-1) according to the embodiment of the present invention;

FIG. 20 is an explanatory diagram of current load data (TABLE6-2) according to the embodiment of the present invention;

FIG. 21 is a flowchart showing a current load calculation process 2 according to the embodiment of the present invention;

FIG. 22 is an explanatory diagram of configuration information (TABLE5) according to the embodiment of the present invention;

FIG. 23 is an explanatory diagram of configuration information (TABLE8) according to the embodiment of the present invention;

FIG. 24 is a flowchart showing an estimated load calculation process according to the embodiment of the present invention;

FIG. 25 is an explanatory diagram of current load data (TABLE7-1) according to the embodiment of the present invention;

FIG. 26 is an explanatory diagram of current load data (TABLE7-2) according to the embodiment of the present invention;

FIG. 27 is a flowchart of a path setup process 1 according to the embodiment of the present invention;

FIG. 28 is a flowchart of a path setup process 2 according to the embodiment of the present invention; and

FIG. 29 is an explanatory diagram of configuration information (TABLE9) according to the embodiment of the present invention.

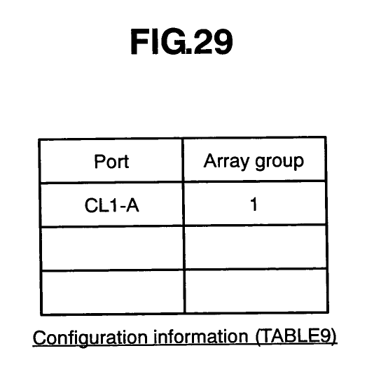

### DETAILED DESCRIPTION OF THE PREFERRED EMBODIMENTS

Embodiments of the present invention will be described in further detail with reference to the accompanying drawings.

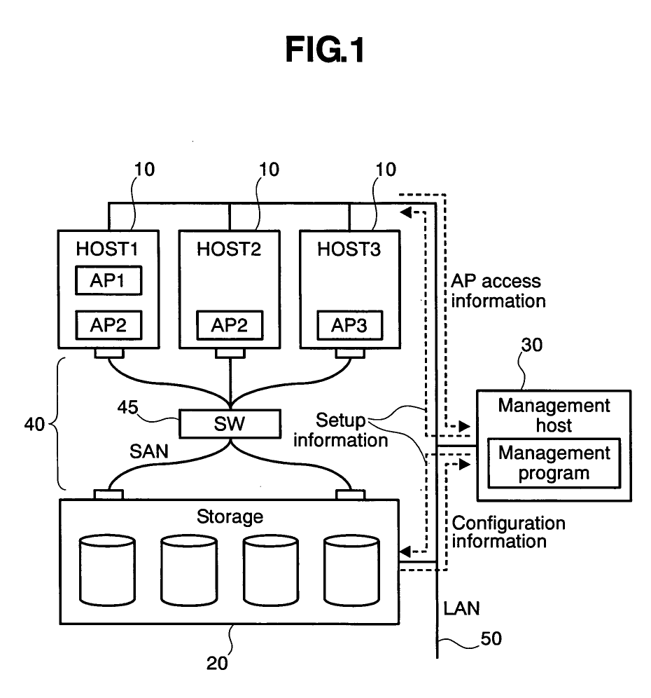

FIG. 1 is a block diagram showing an overall configuration of an information processing system according to an embodiment of the present invention.

The information processing system includes at least one information processing apparatus (host computer), at least one storage (STORAGE) 20, and at least one management host 30. FIG. 1 shows the information processing system comprising three information processing apparatuses 10, one storage 20, and one management host 30. However, the information processing system may comprise any number of information processing apparatuses 10, storages 20, and management hosts 30.

The storage 20 is connected to the information processing apparatus 10 via a network 40 such as SAN (Storage Area Network). The Fibre Channel Protocol is used for communication between the information processing apparatus 10 and the storage 20 via the SAN. That is to say, the information processing apparatus 10 transmits data access requests in units of blocks to the storage 20 according to the Fibre Channel Protocol.

SAN 40 is provided with a fibre channel switch 45 that connects between the information processing apparatus 10 and the storage 20. The information processing apparatus 10 may be directly connected to the storage 20 without providing the fibre channel switch 45.

Further, the information processing apparatus 10 is connected to the storage 20 and the management host 30 via a network 50 such as LAN (Local Area Network). By way of this LAN, the information processing apparatus 10 notifies the management host 30 of AP access information, i.e., information about access to the storage from an application. The storage 20 notifies the management host 30 of configuration information about the storage. Further, the management host 30 notifies the information processing apparatus 10 and the storage 20 of setup information, i.e., information about changing the storage configuration.

The management host 30 communicates with the information processing apparatus 10 and the storage 20 to manage the configuration information about the storage 20. The management host 30 monitors operation states such as errors of a disk controller and the like in the storage 20. In this manner, the management host 30 collects load information about data accesses to the disk controller and the like and cache memory's usage information and the like.

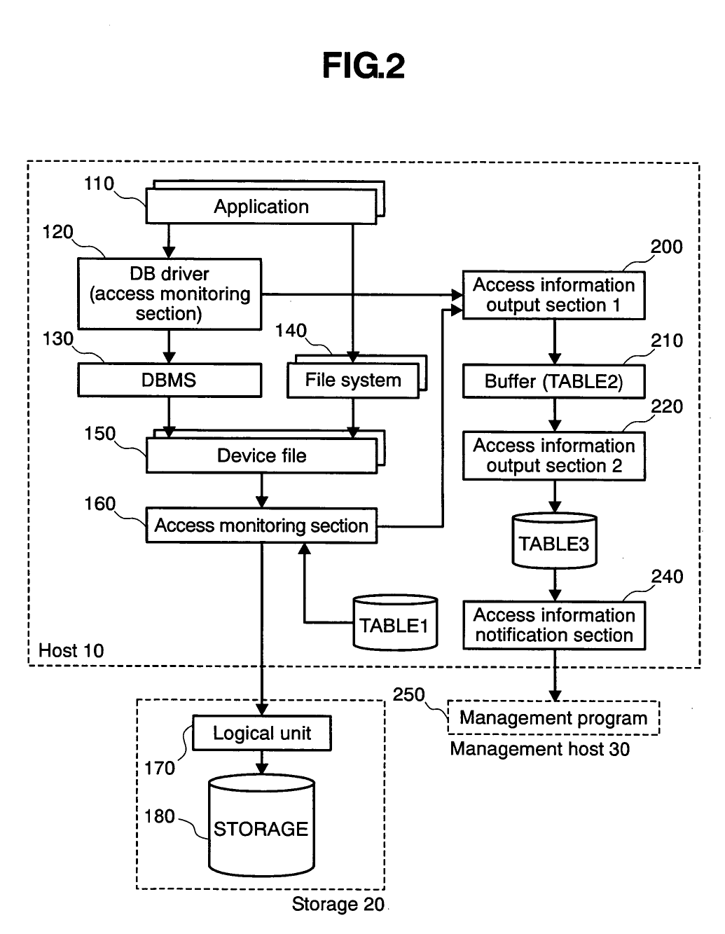

FIG. 2 is a functional block diagram mainly showing the information processing apparatus (host) 10 of the information processing system according to the embodiment of the present invention.

The information processing apparatus (host) 10 has a CPU (Central Processing Unit), memory, and the like. The information processing apparatus 10 follows a command from a LAN-connected client terminal, accesses data stored in the storage 20, and concurrently executes various application programs 110.

A DB driver 120 functions as an interface between the application 110 and a database management system (DBMS) 130. That is to say, the application 110 accesses the DB driver 120 which then activates DBMS 130 to access the database. Further, the DB driver 120 also functions as an access monitoring section that monitors access to the storage (database).

The database management system (DBMS) 130 is software that performs a series of processes and management operations related to the database. The DBMS 130 enables the database itself to operate independently of the application 110 and respond to simultaneous requests from a plurality of applications. The DBMS 130 accesses a device file 150 (to be described) to access the disk (database).

The application 110 can access the storage 180 via not only the above-mentioned DBMS, but also a file system 140. The file system 140 is software that manages data reading and writing in units of files. The file system constructs a hierarchical directory to manage which part of the storage 180 records which files. Based on the information from the file system 140, the application 110 specifies a directory that stores files. The application 110 then accesses the device file 150 to read or write files.

The device file 150 invokes a device driver. The application 110 accesses the device file 150 to activate the device driver installed in the OS kernel, realizing access to the storage 180.

An access monitoring section 160 monitors access to a logical unit 170 from the device file 150. The access monitoring section 160 especially monitors access to files via the file system 140. That is to say, the access monitoring section 160 monitors commands issued from the device driver activated by the device file 150. In this manner, the access monitoring section 160 obtains information about which file was accessed, about the amount of data that is input or output with respect to the access, and the like.

The logical unit 170 is a unit of request for data input and output from the application 110. The logical unit 170 is defined by dividing the storage 180 according to a logical range in terms of control.

The storage (STORAGE) 180 is a storage resource (physical device) provided for the information processing apparatus 10. A hard disk is mainly used for the storage 180. In addition, various storages can be used including a flexible disk, a semiconductor storage, and the like.

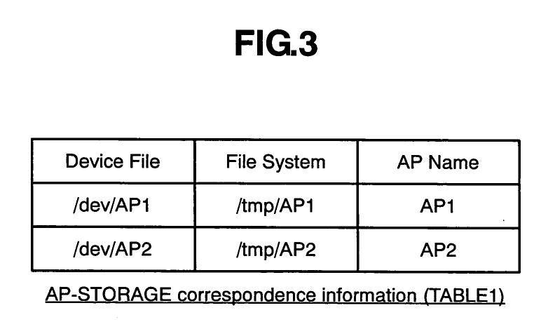

TABLE1 is a table that stores the AP-STORAGE correspondence information. TABLE1 stores a file system name and an application name (AP Name) corresponding to the device file name (FIG. 3). Using this table, the access monitoring section 160 can determine which application 110 issued an I/O request from a device file or a file system accessed to the storage 180. TABLE1 may be stored in the storage 180 or a different medium.

An access information output section 1 (200) receives a result of monitoring accesses to the storage 180 from the access monitoring section 160 (or 120). Based on this result, the access information output section 1 (200) writes the time of access to the storage 180 and the amount of data into buffer memory 210 to generate TABLE2.

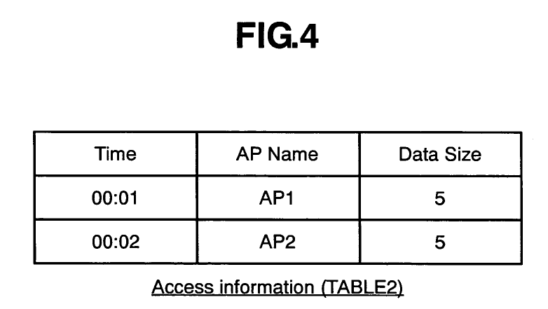

The buffer memory 210 contains TABLE2. When the application 110 accesses the storage 180, TABLE2 temporarily stores the time of this access (Time) and the amount of data (DataSize) concerning the access (FIG. 4). That is to say, when the application 110 accesses the storage 180 using the file system 140, the access monitoring section 160 references the AP-STORAGE correspondence information (TABLE1). The access monitoring section 160 specifies the application that issued the access request from a directory containing files to be accessed. This directory is extracted from a command issued from the device driver. TABLE2 then stores the process time of the access request and the amount of data. On the other hand, when the application 110 accesses the storage 180 using the DBMS 130, the DB driver 120 specifies the application that issued the access request. Alternatively, the AP-STORAGE correspondence information (TABLE1) is referenced to specify the application that issued the access request. TABLE2 then stores the process time of the access request and the amount of data.

An access information output section 2 (220) reads access information from TABLE2 of the buffer memory 210. The access information is stored with the application specified for each access request. The access information output section 2 (220) collects the access information and stores it in an access information table (TABLE3).

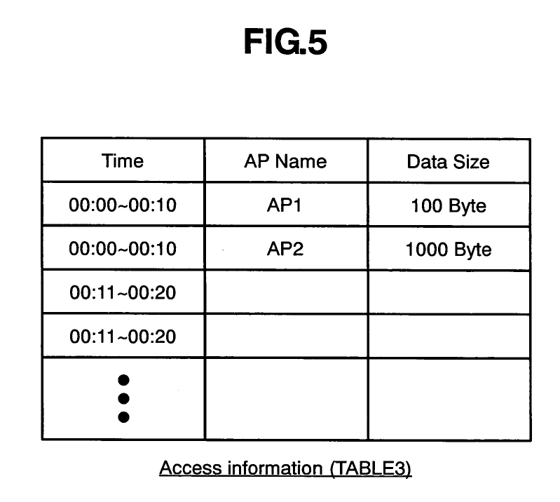

TABLE3 is a table for storing access information. This table stores the time of accessing the storage 180 from the application 110 and the amount of data (DataSize) accessed (FIG. 5). TABLE3 may be stored in the storage 180, the medium containing TABLE1, or a different medium.

An access information notification section 240 sends the access information collected in the TABLE3 format to a management program 250.

The management program 250 is software running on the management host 30 and manages the configuration of the storage 20.

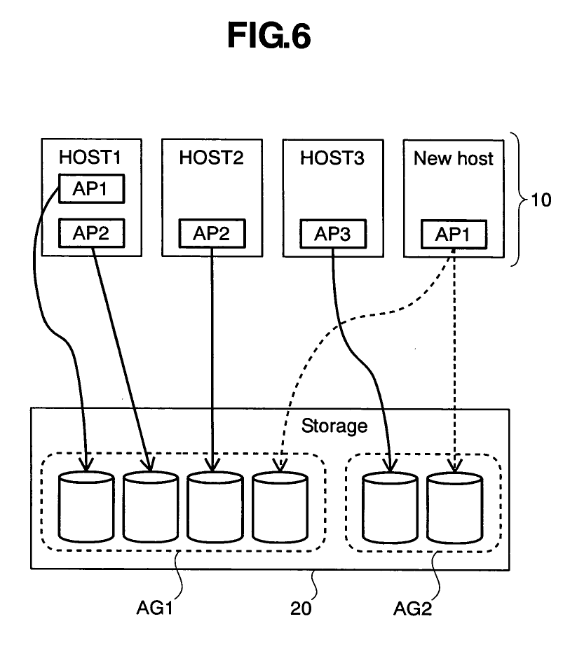

FIG. 6 is an explanatory diagram showing a scheme of calculating estimated loads according to the embodiment of the present invention.

FIG. 6 shows that one or more applications are operating on a plurality of information processing apparatuses (hosts). More specifically, an application 1 (AP1) and an application 2 (AP2) operate on a host 1. The application 2 (AP2) operates on a host 2. An application 3 (AP3) operates on a host 3.

The storage 20 is divided into array groups AG1 and AG2 each comprising a plurality of disk units. The array group provides one virtual area comprising a plurality of redundant physical disk units. The array group may be also referred to as a parity group (ParityGroup).

In the example of FIG. 6, the hosts 1 and 2 access an array group 1 (AG1). The host 3 accesses an array group 2 (AG2).

Adding a new host also adds the application 1 (AP1). At this time, there arises a problem whether the new host should access the array group 1 or 2.

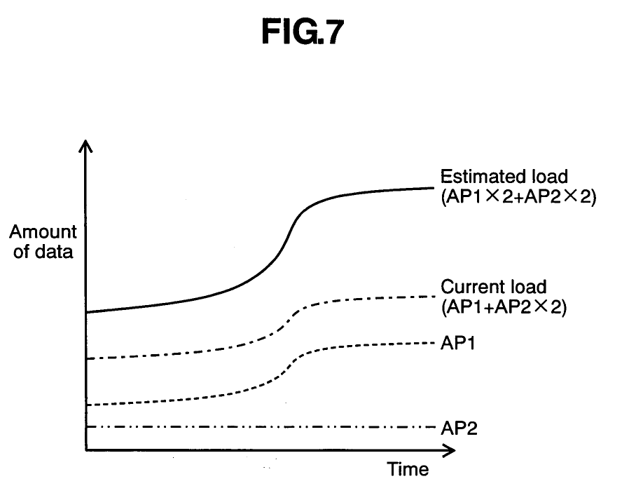

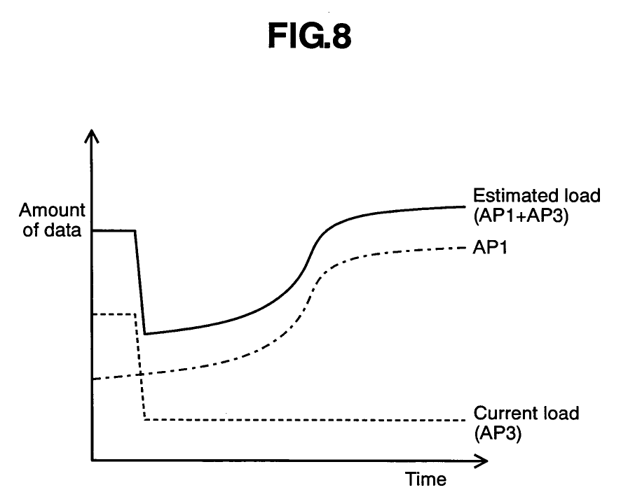

When a new host is added, an estimated load on the array group results from adding a current load and a load of the application 1 to operate on the new host together. As shown in FIG. 7, the current load of the array group 1 results from adding the load of the application 1 to double the load of the application 2. Adding the load of the application 1 to the current load results in an estimated load on connecting the new host to the array group 1. When the new host is connected to the array group 2, the current load of the array group 2 is equivalent to the load of the application 3 as shown in FIG. 8. An estimated load results from adding the current load and the load of the application 1 together.

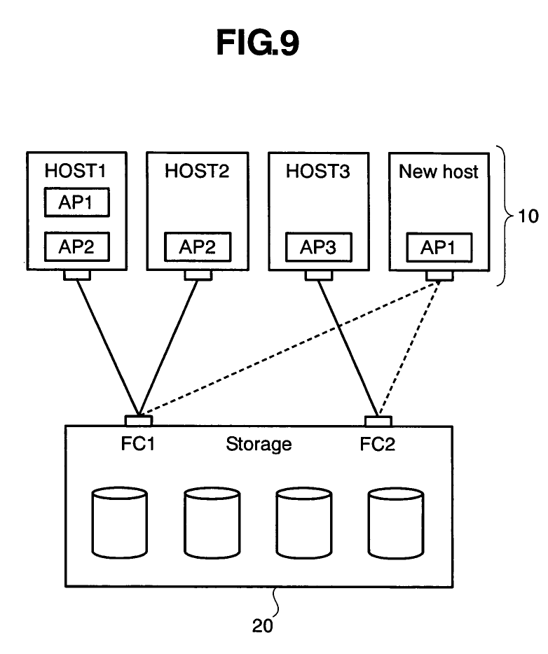

FIG. 9 is an explanatory diagram showing another scheme of calculating estimated loads according to the embodiment of the present invention.

The storage 20 is provided with a plurality of disk units and a plurality of fibre channel ports FC1 and FC2. The hosts 1 and 2 access the disk units via the port 1 (FC1). The host 3 accesses the disk units via the port 2 (FC2).

When adding a new host where the application 1 (AP1) operates, there arises a problem whether the new host should use the port 1 or 2 for access. When the new host is added, an estimated load on the port results from adding the current load and the load of the application 1 operating on the new host together.

When the new host is added, an estimated load on the array group results from adding the current load and the load of the application 1 operating on the new host together. As shown in FIG. 7, the current load of the port 1 results from adding the load of the application 1 to double the load of the application 2. Adding the load of the application 1 to the current load results in an estimated load on connecting the new host to the port 1. When the new host is connected to the port 2, the current load of the port 2 is equivalent to the load of the application 3 as shown in FIG. 8. An estimated load results from adding the current load and the load of the application 1 together.

While the embodiment provides examples of calculating current load situations and estimated load situations for each array group or port, the present invention is not limited thereto. It may be preferable to calculate current load situations and estimated load situations for each controller (Host Bus Adaptor) provided for the storage 20 or for each cache memory that temporarily stores data read from the storage.

In this manner, current load situations and estimated load situations are calculated for each hardware configuration unit. This makes it possible to locate a hardware's faulty portion (bottleneck) during storage access. Loads can be appropriately distributed by allocating a newly added application to the lightly loaded hardware.

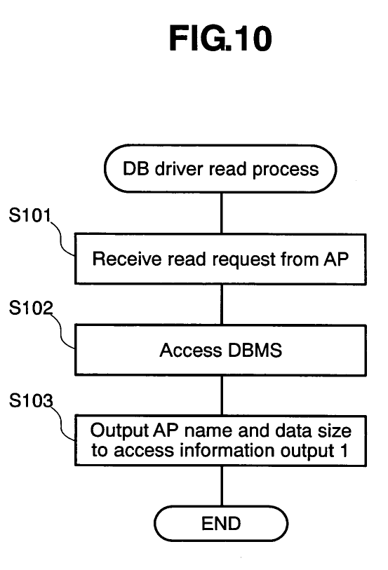

FIG. 10 is a flowchart showing a process of reading data using the DB driver 120 according to the embodiment of the present invention. The process represents how the application 110 reads data from the storage 180 via the DBMS 130.

The DB driver 120 first receives an access request (read request) from the application 110 to read data from the storage 180 (S101). The DB driver 120 accesses the DBMS 130 to specify a directory that contains data specified by the read request. The DB driver 120 specifies the device file 150 for accessing the directory and reads data from the specified device file 150 (S102). With respect to the processed access request, the DB driver 120 outputs the name of the application that issued the access request and the amount of data associated with the access request (S103). The output is made to the access information output section 1 (220).

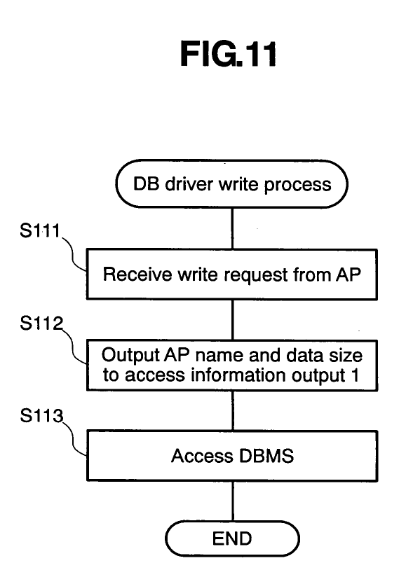

FIG. 11 is a flowchart showing a process of writing data using the DB driver 120 according to the embodiment of the present invention. The process represents how the application 110 writes data to the storage 180 via the DBMS 130.

The DB driver 120 receives, from the application 110, an access request (write request) for writing data to the storage 18Q and data to be written to the storage 180 (S111). The DB driver 120 outputs the name of the application that issued the access request and the amount of data associated with the access request (S112). The output is made to the access information output section 1 (220). The DB driver 120 accesses the DBMS 130 to specify a directory containing a file to which the data is to be written. The DB driver 120 then specifies the device file 150 for accessing the directory and writes the data to the specified device file 150 (S113).

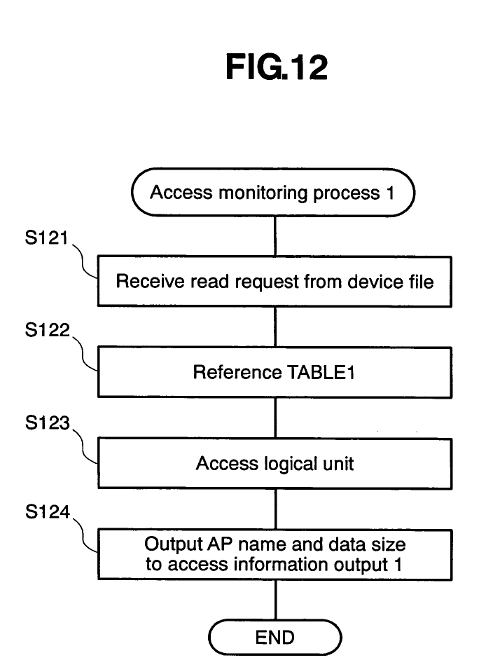

FIG. 12 is a flowchart showing a monitoring process for data reading according to the embodiment of the present invention. The monitoring process (access monitoring process 1) represents how the application 110 reads data from the storage 180 via the file system 140.

The access monitoring section 160 first receives a request (access request) from the device file 150 to read data from the storage 180. From the access request, the access monitoring section 160 extracts a directory containing a file to be read. This directory is specified by the file system 140.

The access monitoring section 160 references the AP-STORAGE correspondence information (TABLE1) to specify the application that issued the access request (S122). This application can be specified from the directory associated with the access request. An access is made from the device file 150 to the logical unit 170 (S123). When this access terminates, the access monitoring section 160 outputs the name of the application that issued the access request and the amount of data associated with the access request (S124). The output is made to the access information output section 1 (220).

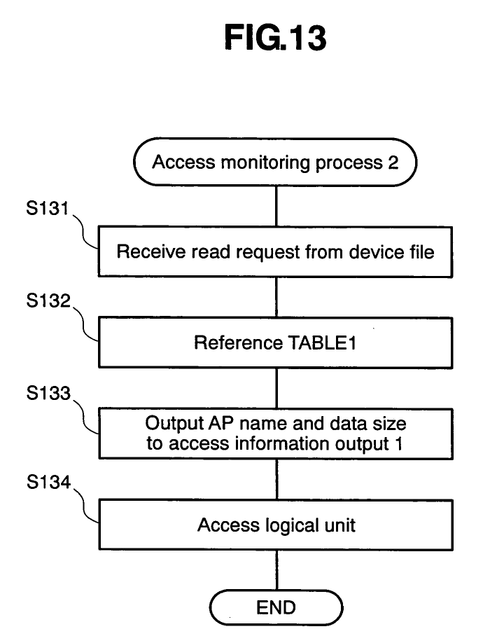

FIG. 13 is a flowchart showing a monitoring process for data writing according to the embodiment of the present invention. The monitoring process (access monitoring process 2) represents how the application 110 writes data to the storage 180 via the file system 140.

The access monitoring section 160 first receives a request (access request) from the device file 150 to write data from the storage 180. From the access request, the access monitoring section 160 extracts a directory containing a file to which data is to be written. This directory is specified by the file system 140.

The access monitoring section 160 references the AP-STORAGE correspondence information (TABLE1) to specify the application that issued the access request (S132). This application can be specified from the directory associated with the access request. The access monitoring section 160 outputs the name of the application that issued the access request and the amount of data associated with the access request (S133). The output is made to the access information output section 1 (220). The access monitoring section 160 permits access to the logical unit from the device file 150 (S134).

As shown in FIGS. 10 through 13, the access information can be obtained for each application whether the application 110 uses the DBMS or the file system to access the storage 180. This is because the access monitoring section 160 performs the monitoring process or the DB driver 120 functions as the access monitoring section 160.

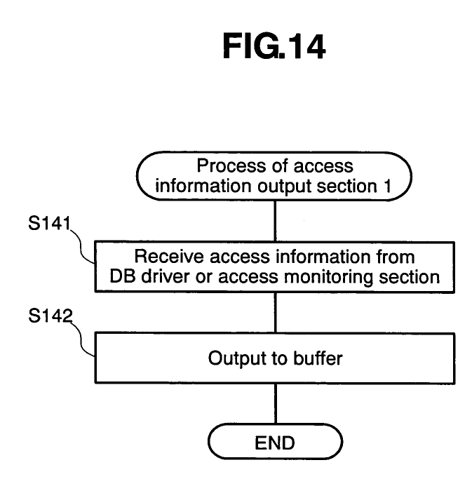

FIG. 14 is a flowchart showing a process of the access information output section 1 according to the embodiment of the present invention.

When the DB driver 120 or the access monitoring section 160 sends access information, the access information output section 1 (220) receives it (S141). The access information output section 1 (220) extracts information such as the name of the application that issued the access request and the amount of data associated with the access request. The extracted information is output to the buffer memory 230 (S142). The access information is written to the buffer memory 230 in the TABLE2 form for storage.

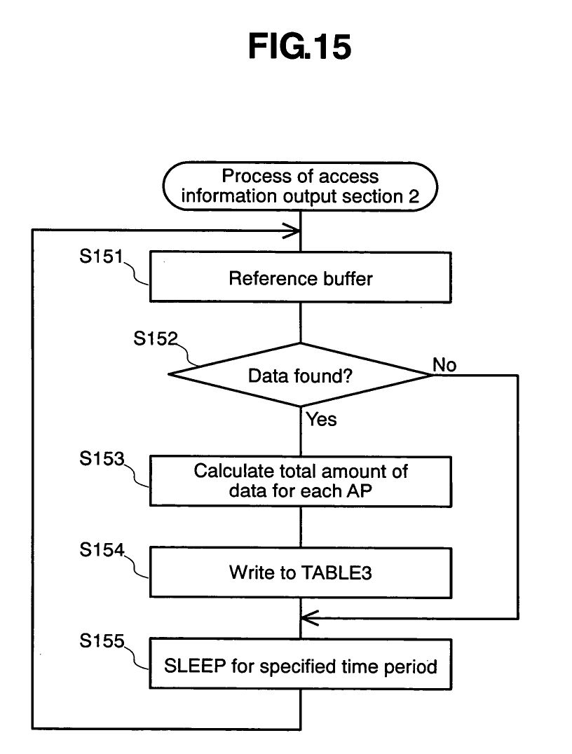

FIG. 15 is a flowchart showing a process of an access information output section 2 according to the embodiment of the present invention.

The access information output section 2 (240) first references TABLE2 stored in the buffer memory 230 (S151). It is determined whether or not the buffer memory 230 (TABLE2) stores data (access information) (S152). If the determination result indicates that no data is stored in the buffer memory 230, the process suspends for a specified time period (S155). Then, control returns to step S151.

If the buffer memory 230 stores data, the access information output section 2 (240) reads the data stored in the buffer memory 230. The access information output section 2 (240) adds up the read data in accordance with successive accesses for each application program to calculate the total amount of data for each application program (S153). The access information output section 2 (240) writes to TABLE3 the name of the application that issued the access request and the amount of data associated with the access request (S154). The access information output section 2 (240) deletes the data stored in the buffer memory. The access information output section 2 (240) suspends for a specified time period (S155), and then returns to step S151.

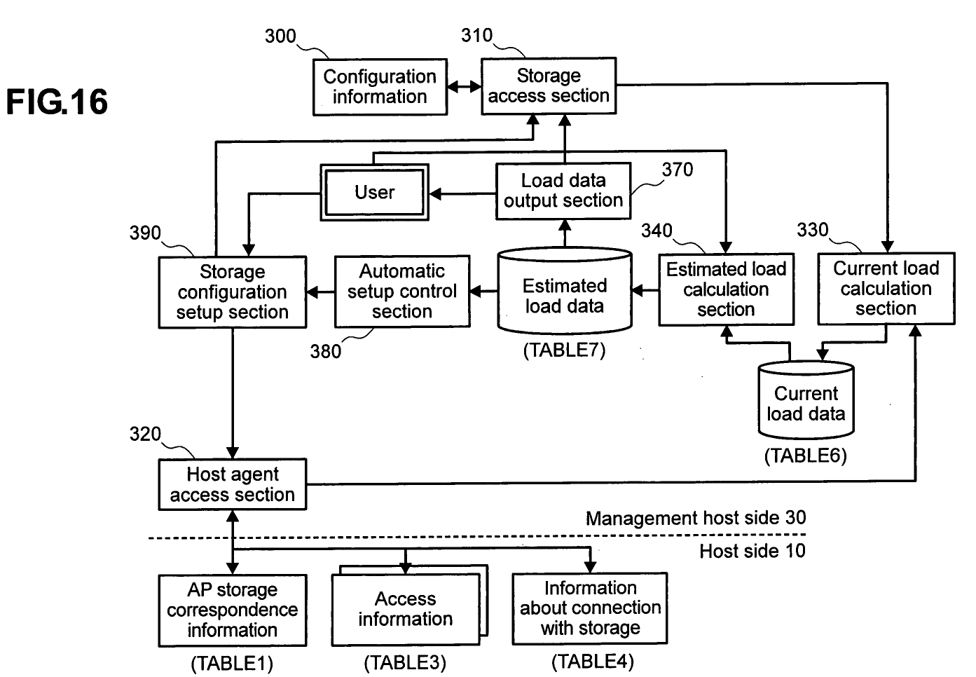

FIG. 16 is a functional block diagram of the management program 250 according to the embodiment of the present invention. The management program 250 runs on management host 30.

Configuration information 300 stores TABLE5, TABLE8, and TABLE9 as information about the storage configuration. That is to say, the configuration information stores correspondence among storages, ports, logical units, logical volumes, and array groups.

A storage access section 310 follows a request from a current load calculation section 330 to read the configuration information needed to calculate current load situations. The storage access section 310 follows a request from a storage configuration setup section 390 to set the configuration information.

A host agent access section 320 obtains the information (TABLE1, TABLE3, and TABLE4) stored in the information processing apparatus (host) 10 and sends the obtained information to the current load calculation section 330.

The current load calculation section 330 adds up storage access situations based on these situations monitored by the access monitoring section 160 (or the DB driver 120). The current load calculation section 330 calculates a current load situation for each array group or port to generate current load data (TABLE6).

An estimated load calculation section 340 calculates a storage access situation for adding an application based on the current load situation calculated by the current load calculation section 330. The estimated load calculation section 340 calculates an estimated load situation for each array group or port to generate estimated load data (TABLE7).

A load data output section 370 displays the estimated load calculated by the estimated load calculation section 340 in a user-recognizable form, e.g., on a display apparatus.

An automatic setup control section 380 selects optimal hardware for adding an application based on the estimated load calculated by the estimated load calculation section 340. The automatic setup control section 380 then issues a command to a storage configuration setup section 390.

Based on the command from the user or the automatic setup control section 380, the storage configuration setup section 390 sends the information about the storage configuration to the storage access section 310 to register it in the configuration information 300. The storage configuration has changed due to addition of the application. The storage configuration setup section 390 sends the information about the changed storage configuration to the host agent access section 320 to update the information stored in the information processing apparatus 10.

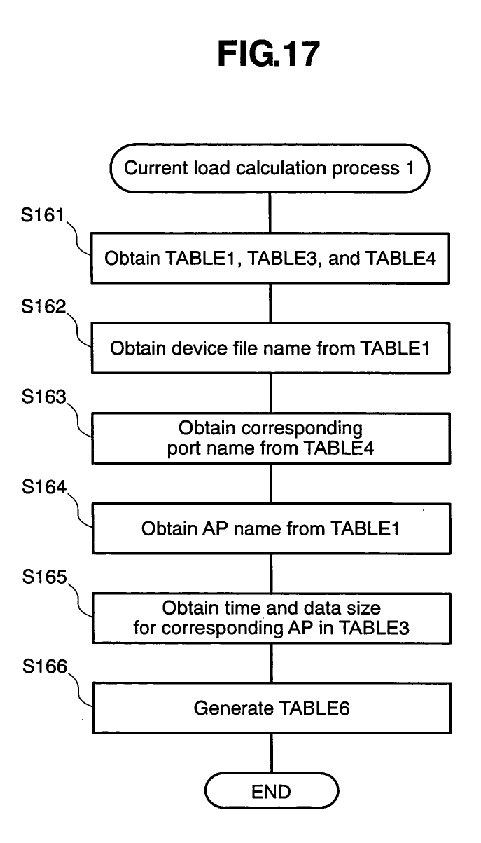

FIG. 17 is a flowchart showing a current load calculation process 1 according to the embodiment of the present invention.

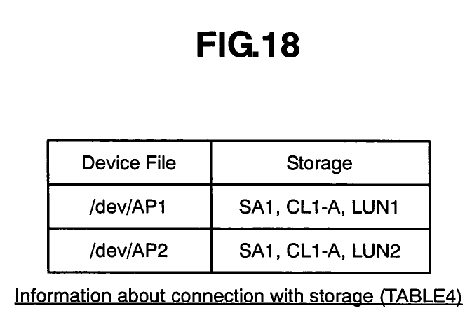

A host agent access section 270 first obtains the AP-STORAGE correspondence information (TABLE1), the access information (TABLE3), and the storage connection information (TABLE4) (S161). As shown in FIG. 18, TABLE4 specifies correspondence between information about device files and storages. The storage information corresponds to the device file and includes a storage name (SA1), a port name (CL1-A), and a logical unit number (LUN1).

The current load calculation section 330 reads a device file name described in the obtained AP-STORAGE correspondence information (TABLE1) (S162). The current load calculation section 330 then obtains a port name corresponding to the device file read from TABLE4 (S163). The current load calculation section 330 again references the AP-STORAGE correspondence information (TABLE1) to obtain an application name corresponding to the device file (S164).

The current load calculation section 330 references TABLE3 to obtain the access process time and the amount of data corresponding to the application name (S165). In this manner, the current load calculation section 330 generates the current load data (TABLE6) that specifies the application name, the amount of data, and the port (or logical unit) corresponding to the access process time (S166).

As mentioned above, the current load calculation process 1 calculates the access time and the amount of data for each port by adding up access times and the amounts of data collected for the applications. Further, the access information output section 1 (200) may specify a controller to process the access and calculate a current load situation using access times and the amounts of data collected for the ports.

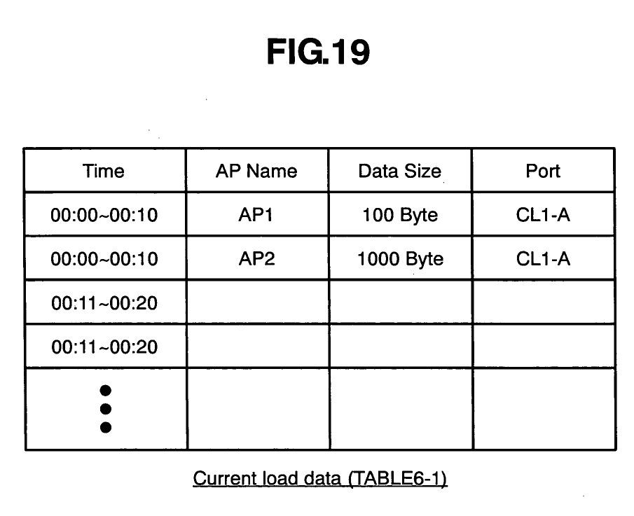

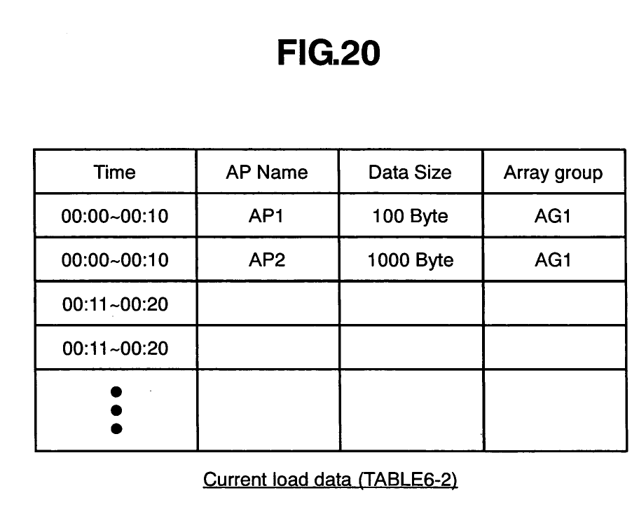

FIGS. 19 and 20 show examples of the current load data (TABLE6) generated by the current load calculation process 1.

FIG. 19 tabulates the access process time and the amount of data corresponding to the application name in terms of a port used by each application. The use of TABLE6-1 (FIG. 19) can add up the amount of data processed for each port by using the time as a variable and calculate the current load situation for each port as a function of the time.

FIG. 20 tabulates the access process time and the amount of data corresponding to the application name in terms of an array group used by each application. The use of TABLE6-2 (FIG. 20) can add up the amount of data processed for each array group by using the time as a variable and calculate the current load situation for each array group as a function of the time.

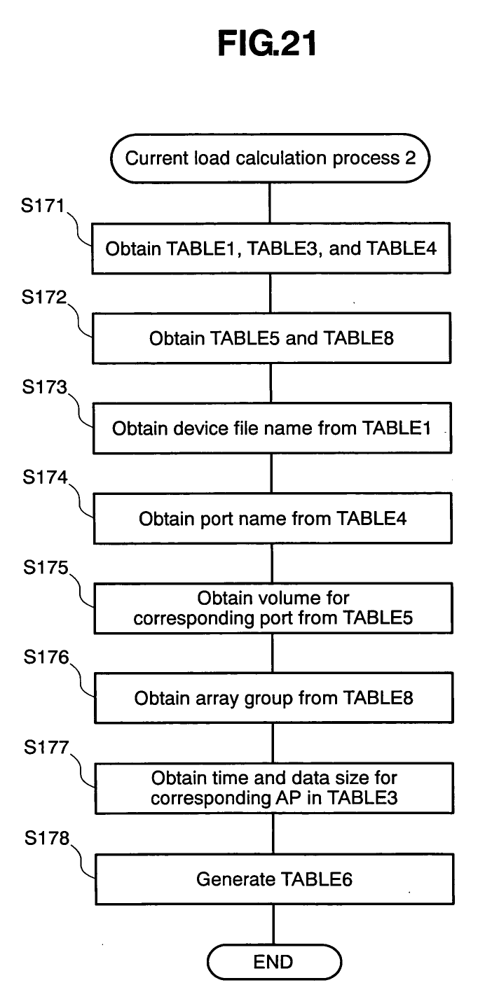

FIG. 21 is a flowchart showing a current load calculation process 2 according to the embodiment of the present invention.

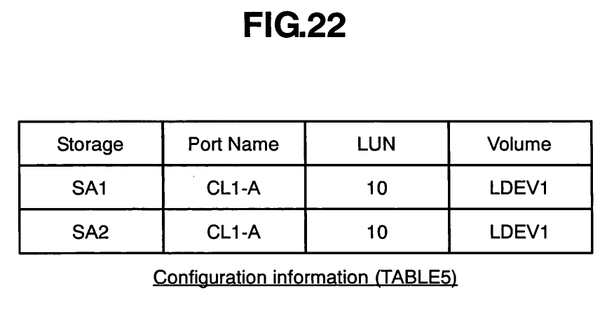

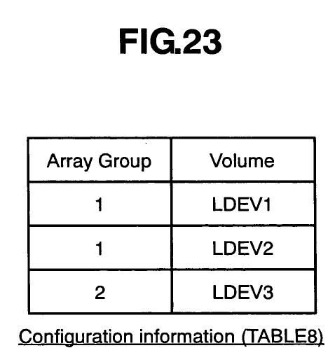

A host agent access section 270 first obtains the AP-STORAGE correspondence information (TABLE1), the access information (TABLE3), and the storage connection information (TABLE4) (S171). The storage access section 310 then obtains TABLE5 and TABLE8 from the configuration information 300 (S172). In the configuration information 300, TABLE5 (FIG. 22) contains a storage name (SA1), a port name (CL1-A), a logical unit number (10), and a logical volume (LDEV1) for each array group. In the configuration information 300, TABLE8 (FIG. 23) contains correspondence between an array group name and a logical volume.

The current load calculation section 330 reads a device file name described in the obtained AP-STORAGE correspondence information (TABLE1) (S173). The current load calculation section 330 then obtains a port name corresponding to the device file read from TABLE4 (S174). The current load calculation section 330 obtains a logical volume corresponding to the port obtained from TABLE5 (S175). Further, the current load calculation section 330 obtains an array group name corresponding to the logical volume obtained from TABLE8 (S176).

The current load calculation section 330 references TABLE3 to obtain the access process time and the amount of data corresponding to the application name (S177). In this manner, the current load calculation section 330 generates the current load data (TABLE6) that specifies the application name, the amount of data, and the port (or logical unit) corresponding to the access process time (S178). The current load data (TABLE6) generated in the current load calculation process 2 is the same as that shown in FIGS. 19 and 20.

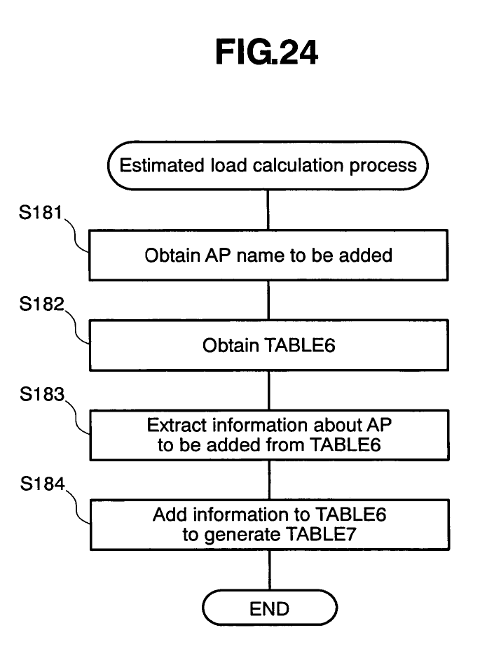

FIG. 24 is a flowchart showing an estimated load calculation process according to the embodiment of the present invention.

A user may need to allocate a new volume when a new directory is added to the file system, for example. In this case, the user specifies an application using a storage resource allocation management program. This allocates a new volume. The file system 140 adds a new directory. When the user specifies an application, it is determined that data of this application is used to calculate an estimated load. Alternatively, the user can select an application that differs from the application to be used actually. The selected application can be used to calculate an estimated load. For example, let us consider a case where there is no load situation data available to the application whose estimated load needs to be calculated. In such case, it is possible to calculate the estimated load by using load data of an application having an approximate load situation.

The estimated load calculation section 340 obtains the name of a user-specified application to be added (S181). The estimated load calculation section 340 then obtains the current load data (TABLE6) (S182).

Further, the estimated load calculation section 340 extracts information about a load caused by the specified application from the current load data (TABLE6) (S183). The estimated load calculation section 340 then adds the information about a load caused by the specified application to the current load data (TABLE6) to generate estimated load data (TABLE7) (S184).

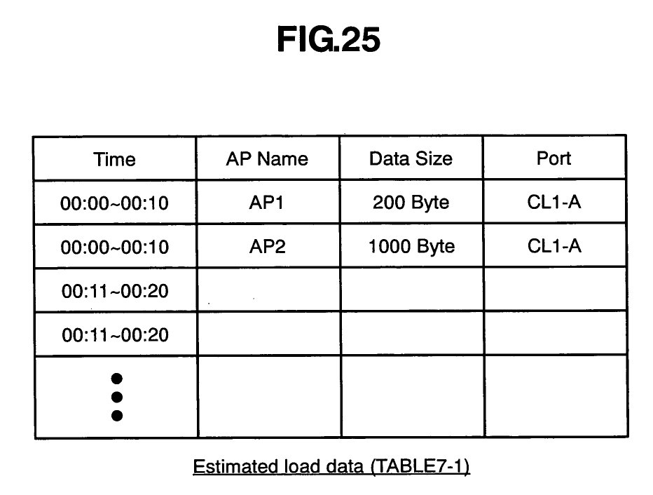

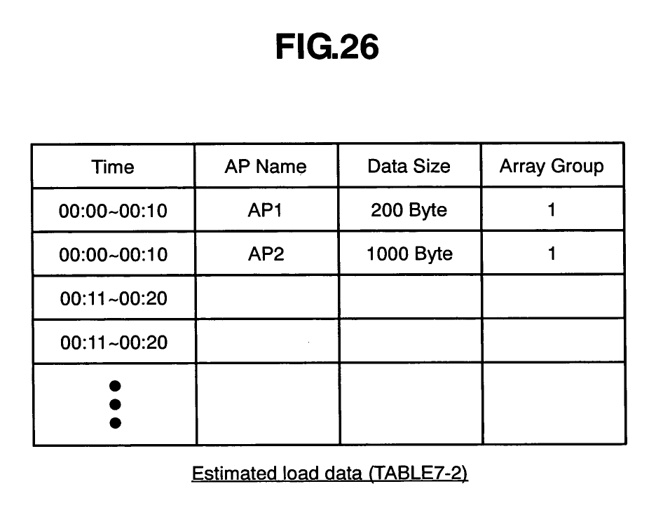

FIGS. 25 and 26 show examples of the estimated load data (TABLE7) generated by the estimated load calculation process.

FIG. 25 tabulates the access process time and the amount of data corresponding to the application name in terms of a port used by each application. The use of TABLE7-1 (FIG. 25) can add up the amount of data processed for each port by using the time as a variable and calculate an estimated value of the load situation for each port.

When the application 1 (AP1) is specified, the amount of data processed by the application 1 is added to the process time. More specifically, the first row of the current load data (TABLE6-1) in FIG. 19 indicates data processed by the application 1 (AP1). Accordingly, the first row of the estimated load data (TABLE7-1) in FIG. 25 is generated by adding this amount of data once more. This is equivalent to doubling the amount of data processed by the application 1.

FIG. 26 tabulates the access process time and the amount of data corresponding to the application name in terms of an array group used by each application. The use of TABLE7-2 (FIG. 26) can add up the amount of data processed for each array group by using the time as a variable and calculate an estimated value of the load situation for each array group.

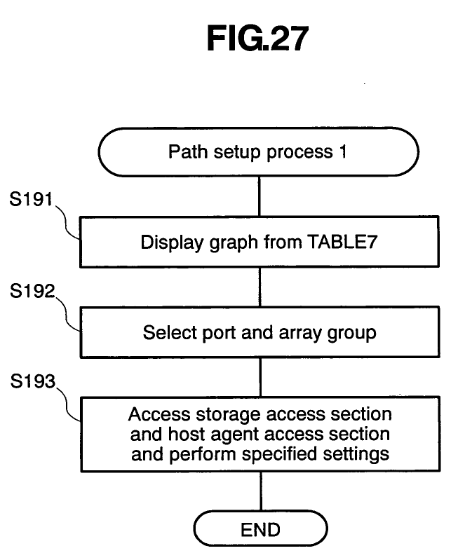

FIG. 27 is a flowchart of a path setup process 1 according to the embodiment of the present invention.

A load data output section 380 obtains the estimated load data (TABLE7) to display the graphs as shown in FIGS. 7 and 8 (S191). Each of the graphs uses the estimated load for the ordinate and the time for the abscissa. The load data output section 380 then prompts the user to select a port and an array group used for the application to be added.

An instruction from the user is input to a storage configuration setup section 320 (S192). The storage configuration setup section 320 accesses the host agent access section 270 and the storage access section 310 to configure settings concerning the port and the array group selected by the user (S193). More specifically, a new device file may be needed for the new application to be added. Further, a new directory may be needed for the new application to be added. In such cases, the host agent access section 270 allocates a new device file or directory to the AP-STORAGE correspondence information (TABLE1).

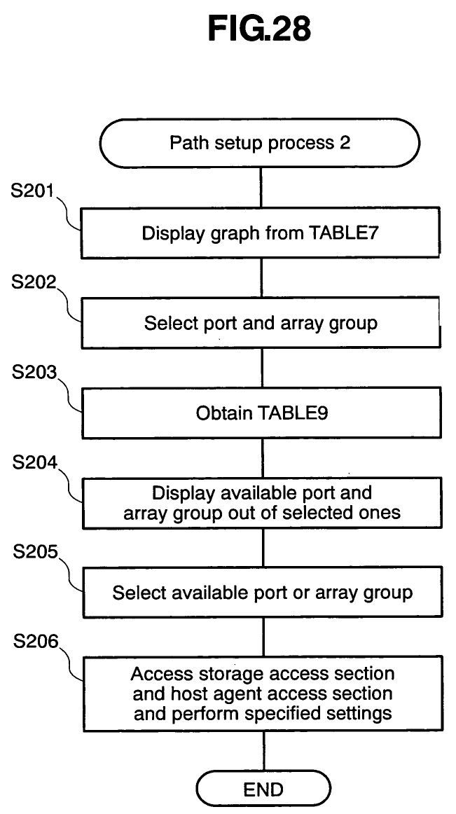

FIG. 28 is a flowchart of a path setup process 2 according to the embodiment of the present invention. Unlike the above-mentioned path setup process 1 (FIG. 27), the path setup process 2 is subject to restriction on the relationship between the port and the array group due to hardware restrictions.

A load data output section 380 obtains the estimated load data (TABLE7) to display the graphs as shown in FIGS. 7 and 8 (S201). Each of the graphs uses the estimated load for the ordinate and the time for the abscissa. The load data output section 380 then prompts the user to select a port and an array group used for the application to be added. The user's selection is input to the storage configuration setup section 320 (S202).

Afterwards, the storage configuration setup section 320 obtains TABLE9 out of the configuration information 300. TABLE9 defines the correspondence between ports and array groups. The port defined in TABLE9 can be used to access the corresponding array group.

The storage configuration setup section 320 references TABLE9 to extract a combination of available ports and array groups out of those selected by the user. The load data output section 380 displays the combination of extracted ports and array groups. The load data output section 380 then prompts the user to select a combination of ports and array groups used for the application to be added (S204). The user's selection is input to the storage configuration setup section 320 (S205).

The storage configuration setup section 320 accesses the host agent access section 270 and the storage access section 310 to configure settings concerning the port and the array group selected by the user (S206).

1. An information processing system comprising an information processing apparatus which is used to operate a plurality of applications to request data input/output from a storage; and a management host which manages said storage,
wherein said storage and said information processing apparatus constitute an access process section for processing an access request from said application;
wherein said information processing apparatus comprises an access monitoring section which monitors an access request from said application and obtains information about said access request for each of said applications; and
wherein said management host comprises:
an acceptance section which accepts specification of a new application;
an estimated load calculation section which calculates estimated load data in case of addition of said new application based on information obtained by said access monitoring section; and
a load data output section which outputs estimated load data calculated by said estimated load calculation section.

2. The information processing system according to claim 1,
wherein said management host comprises a current load calculation section which calculates current load data based on information obtained by said access monitoring section; and
wherein said estimated load calculation section calculates estimated load data in case of addition of said new application based on current load data calculated by said current load calculation section and based on information obtained by said access monitoring section.

3. The information processing system according to claim 1,
wherein said access process section comprises at least first and second access process sections for processing different phases of said access request; and
wherein said estimated load calculation section calculates each of estimated load data in said first access process section and estimated load data in said second access process section when a new application is added.

4. The information processing system according to claim 3,
wherein each of said first and second access process sections includes a plurality of configurations having similar functions;
wherein said configurations for said first and second access process sections comprise a configuration information storage section which stores information about available combinations capable of processing said access request; and
wherein said estimated load calculation section calculates estimated load data with respect to said available combinations of said configurations for said first and second access process sections.

5. An information processing system comprising a storage which stores a database, a plurality of information processing apparatuses which are used to operate an application requesting data input/output from said storage, and a management host which manages said storage,
wherein said information processing apparatus comprises:
a database management system which processes an access request from said application to said database;
an access monitoring section which monitors an access request sent from said application to said database management system and obtains information about said access request; and
an access information output section which collects information about said access request and adds up said information correspondingly to said application, and
wherein said management host comprises:
an acceptance section which accepts specification of a new application;
a current load calculation section which calculates current load data based on information obtained by said access monitoring section;
an estimated load calculation section which calculates estimated load data in case of addition of said new application based on current load data calculated by said current load calculation section and based on information obtained by said access monitoring section;
a load data output section which outputs estimated load data calculated by said estimated load calculation section; and
a configuration setup section which sets up a change in configuration of said storage based on estimated load data calculated by said estimated load calculation section.

6. An information processing system comprising a storage which stores a file, a plurality of information processing apparatuses which are used to operate an application requesting input/output of data stored in a file from said storage, and a management host which manages said storage,
wherein said information processing apparatus comprises:
a file system which processes an access request from said application to said file;
an access monitoring section which monitors an access request sent from said file system to said storage and obtains information about said access request; and
an access information output section which collects information about said access request and adds up said information correspondingly to said application,
wherein said management host comprises:
an acceptance section which accepts specification of a new application;
a current load calculation section which calculates current load data based on information obtained by said access monitoring section;
an estimated load calculation section which calculates estimated load data in case of addition of said new application based on current load data calculated by said current load calculation section and based on information obtained by said access monitoring section;
a load data output section which outputs estimated load data calculated by said estimated load calculation section; and
a configuration setup section which sets up a change in configuration of said storage based on estimated load data calculated by said estimated load calculation section.

7. A control method of an information processing system comprising an information processing apparatus which is used to operate a plurality of applications to request data input/output from a storage; and a management host which manages said storage, said method comprising the steps of:
monitoring an access request from said application;
obtaining information about said access request for each of said applications;
calculating current load data based on information about said obtained access request;
accepting specification of a new application;
calculating estimated load data in case of addition of said new application based on information about said obtained access request;
calculating estimated load data in case of addition of said new application based on said calculated current load data and information about said obtained access request; and
outputting calculated estimated load data.

8. The information processing system control method according to claim 7,
wherein said estimated load data is calculated in case of addition of a new application for each of first and second access process sections to serially process said access request and for possible combinations of configurations of said first and second access process sections.

9. A program to calculate load data in an information processing system comprising an information processing apparatus which is used to operate a plurality of applications to request data input/output from a storage; and a management host which manages said storage,
wherein said program allows said system to function as:
means for monitoring an access request from said application and obtaining information about said access request for each of said applications;
means for calculating current load data based on information about said obtained access request;
means for accepting specification of a new application;
means for calculating estimated load data in case of addition of said new application based on information about said obtained access request;
means for calculating estimated load data in case of addition of said new application based on said calculated current load data and information about said obtained access request; and
means for outputting said calculated estimated load data.

10. The program according to claim 9,
wherein said means for calculating estimated load data calculates estimated load data in case of addition of a new application for each of first and second access process sections to serially process said access request and for possible combinations of configurations of said first and second access process sections.
